(19) United States
(12) Patent Application Publication
(10) Pub. No.: US 2018/0185920 A1
(43) Pub. Date: Jul. 5, 2018

(54) LEVER FOR ACTUATING GAS EXCHANGE VALVES OF AN INTERNAL COMBUSTION ENGINE

(71) Applicant: Schaeffler Technologies AG & Co. KG, Herzogenaurach (DE)

(72) Inventors: Holger Pätzold, Burgebrach (DE); Frank Himsel, Obermichelbach (DE); Hans Mönius, Adelsdorf (DE)

(73) Assignee: Schaeffler Technologies AG & Co. KG, Herzogenaurach (DE)

(21) Appl. No.: 15/741,523

(22) PCT Filed: Aug. 12, 2016
(86) PCT No.: PCT/DE2016/200375

§ 371 Date: Jan. 3, 2018

(30) Foreign Application Priority Data
Sep. 22, 2015 (DE) 10 2015 218 144.8

(51) Int. Cl. B22F 5/00; B22F 7/06; B22F 3/22; F01L 1/18

(52) U.S. Cl. CPC B22F 5/008; B22F 7/06; B22F 3/225; B33Y 80/00; C04B 2235/6022; F01L 2101/02; F01L 2103/00; F01L 1/181

(57) ABSTRACT

A lever arranged for actuation by a cam for the purpose of actuating gas exchange valves of an internal combustion engine is provided. The lever has a contact pad which is configured at one end of the lever on the underside thereof for at least one gas exchange valve, and a contact face for a supporting element, arranged at an opposite end of the lever on the underside. At least one cam thrust face is arranged on an upper side in a region between the contact pad and the contact face. The lever can be loaded is can be manufactured in one piece as either a 2C-MIM (2-Component Metal Injection Molding) component, combined 2C-MIM component and CIM (Ceramic Injection Molding) component, or as a 2C-sintered part having two metal components or having one metal component and one ceramic component.

### CROSS-REFERENCE TO RELATED APPLICATIONS

This application is the U.S. National Phase of PCT Application No. PCT/DE2016/200375 filed Aug. 12, 2016 which claims priority to DE102015218144.8 filed Sep. 22, 2015, the entire disclosures of which are incorporated by reference herein.

### TECHNICAL FIELD

The invention relates to a lever arranged for actuation by a cam for the purpose of actuating gas exchange valves of an internal combustion engine, having on the underside of one end of the lever a contact pad for at least one gas exchange valve, having on the underside of an opposite end of the lever a contact face for a support element, and having on an upper side, in a region between the contact pad for the at least one gas exchange valve and the contact face for the support element, at least one cam thrust face.

### BACKGROUND

A switchable rocker arm is known from DE 10 2007 029 465 A1. This switchable rocker arm has an outer lever, an inner lever being arranged between the arms of the former so as to be able to pivot relative thereto, wherein at least the inner lever has a cam thrust face on its upper side, and the outer lever and the inner lever are arranged on a common axis so as to be able to pivot relative to one another. A spring element acting between the two levers holds the inner lever in position with respect to the outer lever, the outer lever having a contact face for a support element and a coupling means that can be brought into engagement with a driver face of the inner lever in a coupling case.

Rocker arms of this kind, which during operation are subject to high mechanical and/or thermal loads, are made of a high-strength material. Inserts which are very resistant to wear and are for example made of hard metal are often arranged in the region of the cam thrust faces. Preferably, the constituent elements of switchable rocker elements of this kind are produced from homogeneous materials as investment casting parts or using the MIM (metal injection molding) method.

The switchable rocker arm known from DE 10 2007 029 465 A1 is provided with the above-mentioned spring element in the region of the contact pad for at least one gas exchange valve, which increases the mass moment of inertia of the switchable rocker arm for actuating a gas exchange valve, which limits the maximum possible engine speed of the internal combustion engine provided therewith.

Making the above-mentioned parts out of a high-strength material throughout increases material costs. By contrast, providing only the cam thrust faces, that are subjected to high mechanical loads, with inserts made of hard metal increases manufacturing costs.

### SUMMARY

This disclosure is based on the object of proposing a lever arranged for actuation by a cam, is cost-effective to produce and, owing to a reduced mass moment of inertia, is suitable for higher engine speeds of the internal combustion engine. Also to be specified is a production method with which it is possible to produce such a lever, such as a rocker arm.

This device-related object is achieved in two alternative variants with a lever arranged for actuation by a cam. Advantageous developments of these levers are described herein, including production methods.

Thus, the disclosure relates first to a lever arranged for actuation by a cam for the purpose of actuating gas exchange valves of an internal combustion engine, in particular a rocker arm, having on the underside of one end of the lever a contact pad for at least one gas exchange valve, having on the underside of an opposite end of the lever a contact face for a support element, and having on an upper side, in a region between the contact pad for the at least one gas exchange valve and the contact face for the support element, at least one cam thrust face.

In order to solve the device-related problem, it is provided that the lever arranged for actuation by a cam is produced in one piece as a 2C-MIM (two-component metal injection molding) part, or as a combined 2C-MIM part and CIM (ceramic injection molding) part, wherein the lever is formed from of a material having good machining properties, as a first component, and at least the cam thrust face of the lever is formed from a material having good wear resistance, as a second component.

Machinability is determined primarily by the metallurgical and mechanical properties of the material and by the micro- and macro-scale geometry of the cutting edge that is to be used, and by the cutting material itself. The machinability includes on one hand the ability to machine a material and on the other hand the wear produced on the cutting edge, as well as the chip formation that is to be achieved. “Good” machinability is understood in this case to mean undisturbed machining and fair tool life.

Materials having good wear resistance are in particular alloyed tool steels having up to 2.06% carbon content and a high proportion of alloying elements such as chromium (3-5%), tungsten (0-15%), molybdenum (0-10%), vanadium (0-6%), cobalt, nickel and titanium, see DIN EN ISO 4957 from February 2001. These materials are thermally stable up to approximately 600° C. and are characterized by high hardness, tempering resistance and wear resistance. The density of such materials is in particular in the range from 7830 to 8400 kg/m³, the modulus of elasticity is in particular 217-240 kN/mm².

The first component is a material having a ductile core and high tensile strength at the surface of the part (case-hardening), and the second component is a material that exhibits no decrease in hardness throughout its depth (through-hardening).

The previously described lever arranged for actuation by a cam for the purpose of actuating gas exchange valves of an internal combustion engine, in particular a rocker arm, can be produced in one piece as a 2C-sintered part having two metal components, or having one metal component and one ceramic component. The lever is formed from a material having good machining properties, as the first component, and at least the cam thrust faces of the lever are formed from a material having good wear resistance, as the second component.

The first component of the lever that is produced as a 2C-MIM part or as a combined 2C-MIM and CIM part or as a 2C-sintered part can in that context be a roller bearing steel which has good machinability and can be produced by metallurgy, for example 1000r6; the second component at least of the cam thrust face of the lever that is produced as a 2C-MIM part or as a combined 2C-MIM and CIM part or as a 2C-sintered part can be, for example of a high-speed steel, such as Vanadis 23, which has good wear resistance and can be produced by powder metallurgy. Other materials, in addition to 1000r6, that have good machinability and can be used to make the lever are for example 16MnCr5 or C45.

This makes it possible to dispense with the currently necessary procedure of coating the lever, and the use of cost-effective materials in less critical regions of the lever make it possible to further reduce production costs.

The at least one cam thrust face can be formed by the circumferential face of a roller mounted on the lever so as to be able to rotate, wherein the circumferential face is formed by the second component of the roller that is produced as a 2C-MIM part or as a combined 2C-MIM and CIM part or as a 2C-sintered part, and the roller body is formed essentially by the first component.

The lever can be designed as a switchable rocker arm having a valve actuation lever and a pivotable switching lever; on the underside of one end of the valve actuation lever there is a contact pad for at least one gas exchange valve and, at the opposite end, there is a contact face for a support element; on the upper side, in the region between the contact pad for at least one gas exchange valve and the contact faces for the support element, at least one cam thrust face is present; one end of the switching lever is articulated, via a projection, to the valve actuation lever by means of an axle; the opposite end can be brought into engagement, via a transverse web, with a coupling assembly; at least one cam thrust face is arranged in the region between the ends of the switching lever on the upper side of the lever; the valve actuation lever and the switching lever can be formed of the first component, and at least the cam thrust faces of the valve actuation lever and of the switching lever can be formed of the second component produced in one piece as a 2C-MIM part or as a combined 2C-MIM and CIM part or as a 2C-sintered part.

In this embodiment as a switchable rocker arm, it can be provided that the at least one cam thrust face of the valve actuation lever and/or of the switching lever is formed by the circumferential face of at least one roller that is mounted on the valve actuation lever and/or on the switching lever so as to be able to rotate, wherein the circumferential face of the roller is formed by the second component of the roller that is produced as a 2C-MIM part or as a combined 2C-MIM and CIM part or as a 2C-sintered part, and the roller body is formed by the first component.

A method is provided for producing a lever arranged for actuation by a cam for the purpose of actuating gas exchange valves of an internal combustion engine. The lever and its components are produced as one-piece parts using the 2C-MIM method or the combined 2C-MIM and CIM method, or the 2C-sintering method. Load-bearing regions of the lever and its components are formed from a material having good machining properties as a first component, and the cam thrust faces are formed from a material having good wear resistance as a second component.

Another solution to the problems mentioned in the introduction lies in the use of the 2C-MIM method or the combined 2C-MIM and CIM method, or the 2C-sintering method, for producing a lever arranged for actuation by a cam for the purpose of actuating gas exchange valves of an internal combustion engine.

### BRIEF DESCRIPTION OF THE DRAWINGS

The invention is explained in greater detail below with reference to an exemplary embodiment illustrated in the drawing, in which:

FIG. 1 shows a longitudinal section, along a line A-A in FIG. 2, through a lever arranged for actuation by a cam,

FIG. 2 shows a plan view of the lever arranged for actuation by a cam, which is shown in FIG. 1 and is designed as a switchable rocker arm,

FIG. 3 shows a side view of the lever shown in FIGS. 1 and 2, and

FIG. 4 shows an end view of the lever shown in FIGS. 1 to 3.

### DETAILED DESCRIPTION

A lever 1 arranged for actuation by a cam and is designed as a switchable rocker arm has, as shown best in FIG. 2, a valve actuation lever 2 with two mutually parallel side walls 3, 3′. These two side walls 3 transition, in the direction toward a gas-exchange-valve-side end 9 of the lever 1, into two transverse walls 4, 4′ running approximately perpendicular to the parallel side walls 3, 3′, which transverse walls end, on either side of a central line characterized by the arrows A-A, in two projections 5, 5′ running parallel to one another.

These parallel projections 5, 5′ are connected to one another by a transverse web 6 of which the underside forms a contact pad 7 for a tappet of a gas exchange valve. In the continuation of the two parallel projections 5, 5′, in the direction of an underside 32 of the lever 1 arranged for actuation by a cam, there are parallel guide tabs 8, 8′ that wrap around an end of a tappet of the gas exchange valve, which is not shown, and hold the lever 1 in position with respect to the gas exchange valve.

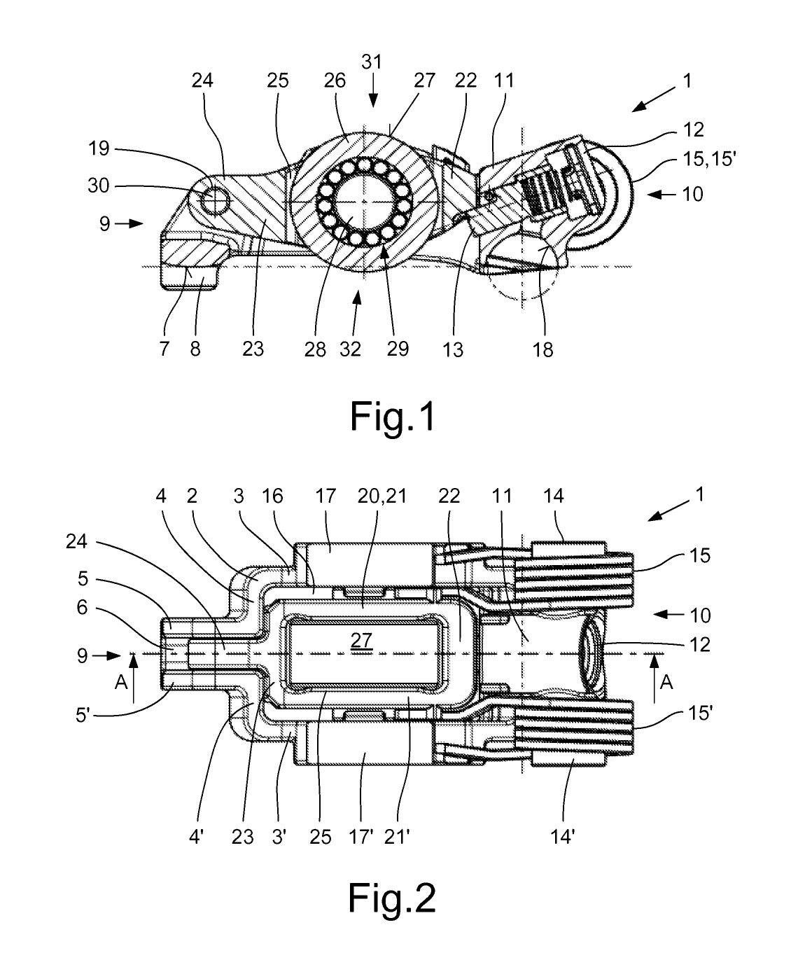

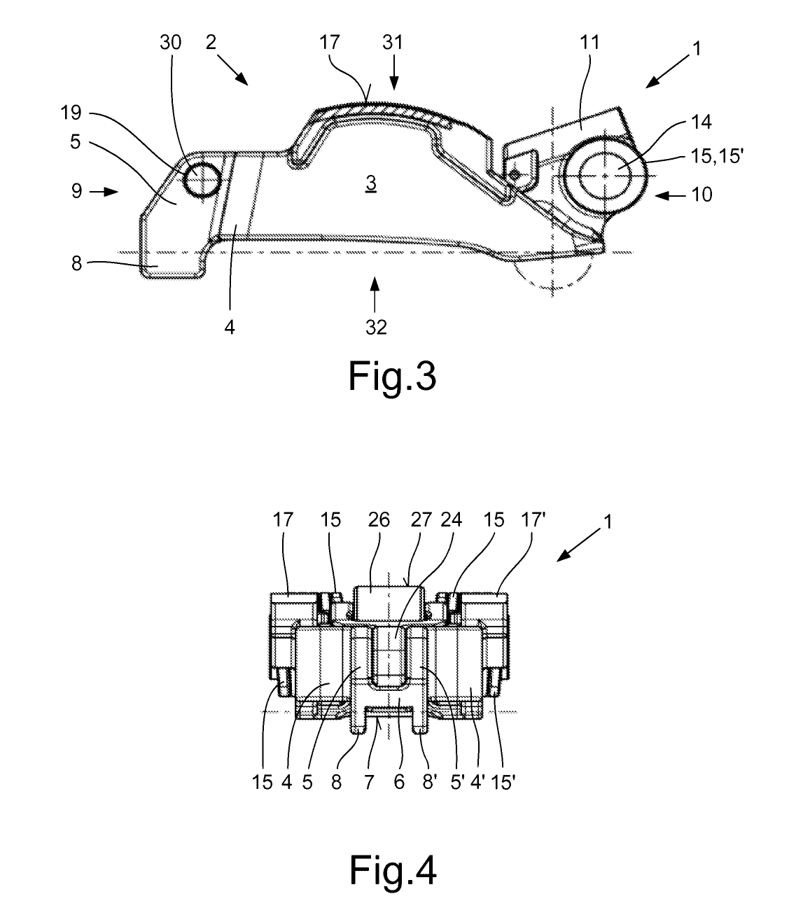

In the opposite direction from the gas-exchange-valve-side end 9 of the lever 1, the valve actuation lever 2 has a transverse connection 11 that has, on the underside 32 of the lever 1, a contact face 18 for a support element which is not illustrated. The transverse connection 11 is provided with a receiving portion 12 for a coupling assembly 13 including a piston which, as illustrated in FIG. 1, can be brought by spring pressure into engagement with a transverse web 22 on a switching lever 20, and by means of hydraulic pressure can be brought out of engagement with this transverse web 22 via an opening in the contact face 18 for the support element.

The transverse connection 11 of the valve actuation lever 2 also has two projections 14, 14′, each for receiving a torsion leg spring 15, 15′ of a torsion leg spring pair, the ends of which press against the side walls 3, 3′ of the valve actuation lever 2 and against the support-element-side end 10 of the switching lever 20, and hold the switching lever 20 in the position shown in FIG. 1 when the coupling assembly 13 including a piston has been brought, by hydraulic pressure, out of engagement with the transverse web 22.

A coaxial pair of apertures 19 is formed in the two mutually parallel end-side projections 5, 5′ of the valve actuation lever 2 and serves to receive an axle 30 by means of which the switching lever 20 is pivotably mounted on the valve actuation lever 2.

An essentially rectangular receiving portion 16 for the switching lever 20 is formed between the two mutually parallel side walls 3, 3′, the two transverse walls 4, 4′ and the transverse connection 11. This switching lever 20 comprises two mutually parallel side legs 21, 21′ which are connected to one another by means of a transverse web 22 toward the support-element-side end 10 and by means of a transverse wall 23 toward the gas-exchange-valve-side end 9. An axial projection 24, which extends between the two parallel projections 5, 5′ of the valve actuation lever 2, is formed centrally on the transverse wall 23 and serves to pivotably connect the switching lever 20 to the valve actuation lever 2 by means of the bolt 30.

A receiving portion 25 for a roller 26, whose circumferential face forms a cam thrust face 27 in the region of the upper side 31 of the switchable rocker arm 1, is formed by the two parallel side legs 21, 21′, the transverse web 22 and the transverse wall 23. The roller 26 is arranged mounted in the switching lever 20 by means of an axle 28 and needle bearings 29 such that it is able to rotate.

For the operation of a switchable rocker arm of this type, reference is made to DE 10 2007 029 465 A1, the relevant content of which is hereby fully made the subject matter of the present disclosure.

The valve actuation lever 2 and the switching lever 20, together with two cam thrust faces 17, 17′ on the valve actuation lever 2 and possibly also the contact pad 7 for a gas exchange valve, the contact face 18 for a support element and the cam thrust face 27 on the roller 26 on the switching lever 20 are in each case made in one piece as a 2C-MIM part or as a combined 2C-MIM and CIM part or as a 2C-sintered part having two metal components, or having one metal component and one ceramic component, wherein the valve actuation lever 2 and the switching lever 20 consist essentially of a material having good machining properties as the first component, and the cam thrust faces 17, 17′, 27 and possibly also the contact pad 7 for a gas exchange valve and the contact face 18 for a support element consist of a material having good wear resistance as the second component.

The first component of the valve actuation lever 2, of the switching lever 20 and of the roller 26 can be formed from a roller bearing steel which has good machinability and can be produced by powder metallurgy, for example 100Cr6, while the second component at least of the cam thrust faces 17, 17′, 27 of the valve actuation lever 2, of the switching lever 20 or of the roller 26 can be formed from a material Vanadis 23, a high-speed steel, which can be produced by powder metallurgy.

The valve actuation lever 2, the switching lever 20 and the roller 26 are for example produced using a 2C-MIM method or a combined 2C-MIM and CIM method or a 2C-sintering method. The components are injection-molded into a tool using the powder injection-molding method. The components are then dried, debinded (that is to say the binder is removed) and heated or sintered. Production using the 2C-MIM method or the combined 2C-MIM and CIM method or also the 2C-sintering method has the advantage that it is also possible to produce complex or complicated geometries. It is thus possible, using this technology, to produce wall thicknesses of less than approximately 1 mm. In that context, production tolerances are relatively small. In addition, these technologies make it possible to produce surfaces with a thickness more than three times the diameter of the grain size of the metal powder. The layer separation is ideally below the maximum of the Hertzian contact stress occurring during operation in a component coated in this manner.

When producing the powder injection-molding mixtures, use is made of binder systems in order to be able to process the metal powders using injection-molding machines. The aim of the preparation is to coat all of the powder particles with the binder system, that is to say prevent or destroy agglomerates of powder grains and produce a granulate that is as homogeneous as possible. As starting materials for the injection-molding of metal powder, use can be made for example of all sinterable powders having a suitable grain size, such as metals, hard metals, steel material, low-alloy steel material, high-grade steel material, precious metals, carbonyl iron material, carbonyl iron material having approximately 50% by mass of nickel, tungsten carbide having approximately 12% by mass of cobalt, and metal alloys, in particular superalloys. The grains of the metal powder used preferably have an average grain size of approximately 4 μm to approximately 20 μm. It is also possible to use silicate ceramics, oxide ceramics or non-oxide ceramics; mention may merely be made by way of example of aluminum oxide, magnesium oxide, zirconium oxide, aluminum titanate and piezoceramics, and also carbides or nitrides.

For forming, the granulate is pressed by means of a heated extruder into cooled, for example liquid-cooled, tools. The extruder screw and the extruder cylinder are preferably made of a relatively hard material, in particular steel material or bimetallic material. After the injection-molding process, the parts, also referred to as green bodies, are demolded from the tool.

Wax materials can be used as the binder system. The wax material is melted out of the green body by relatively slow heating. This procedure is termed debinding and the resulting porous molded part is referred to as a brown body. Thermoplastic material, polyalcohols, polyoxymethylene (POM) or polyvinyl alcohols can also be used as binder systems.

The final step of sintering turns the brown body into the end product. The brown body is heated in a sintering furnace. The temperature is approximately 1200° C. to approximately 1300° C. Sintering can take place under a protective gas atmosphere of nitrogen or hydrogen, possibly in a vacuum.

The use of the 2C-MIM method or the combined 2C-MIM and CIM method, or the 2C-sintering method, for producing a switchable rocker arm arranged for actuation by a cam and of which the valve actuation lever 2 and the switching lever 20 are formed from a material having good machining properties as the first component, and of which the cam thrust faces 17, 17′, 27 are formed from a material having good wear resistance as the second component, makes it possible to produce complex and complicated geometries and makes it possible to join different materials to give a one-piece part. This means that production costs are markedly reduced in comparison since it is possible for example to dispense with the currently necessary step of coating, and the use of more cost-effective material in less critical regions makes it possible to reduce material costs.

All of the features mentioned in the above description of the figures, in the claims and in the introduction to the description can be used both individually and in any combination with one another. Thus, the invention is not limited to the combinations of features as described and claimed, but rather all combinations of features should be considered as having been disclosed.

### LIST OF REFERENCE CHARACTERS

1 Lever that can be acted on by a cam, switchable rocker arm
2 Valve actuation lever
3 Parallel side walls
4, 4′ Transverse walls
5, 5′ Parallel projections
6 Transverse web
7 Contact pad for gas exchange valve
8, 8′ Guide tabs
9 Gas-exchange-valve-side end
10 Support-element-side end
11 Transverse connection
12 Receiving portion for coupling assembly
13 Coupling assembly, piston
14, 14′ Lateral projections
15, 15′ Torsion leg springs
16 Receiving portion for the switching lever
17, 17′ Cam thrust face
18 Contact face for a support element
19 Coaxial pair of apertures
20 Switching lever
21, 21′ Parallel side legs
22 Transverse web of the switching lever
23 Transverse wall
24 Projection
25 Receiving portion for a roller
26 Roller
27 Cam thrust face, circumferential face of the roller
28 Axle
29 Needle bearing
30 Axle for the switching lever
31 Upper side of the switchable rocker arm
32 Underside of the switchable rocker arm

1. (canceled)

2. (canceled)

3. (canceled)

4. (canceled)

5. (canceled)

6. (canceled)

7. (canceled)

8. (canceled)

9. (canceled)

10. A lever arranged for actuation by a cam, having:
on an underside of one end of the lever a contact pad configured to contact at least one gas exchange valve;
on an underside of an opposite end of the lever a contact face configured for a support element; and,
an upper side between the contact pad and the contact face, the upper side having at least one cam thrust face; and,
the lever is produced in one piece as a two-component metal injection molding part, or as a combined two-component metal injection molding and ceramic injection molding part, or as a two-component sintered part having two metal components, or having one metal component and one ceramic component; and,
wherein a lever material comprises a first component and a second component, the second component forming at least the at least one cam thrust face of the lever.

11. The lever of claim 10, wherein:
the first component is a material having a core hardness that is less than a surface hardness; and,
the second component is a material that maintains a constant hardness throughout its depth.

12. The lever of claim 10, wherein:
the first component is a roller bearing steel; and,
the second component is a high-speed steel.

13. The lever of claim 10, wherein the first component comprises a roller bearing steel of either of types 100Cr6, 16MnCr5 or C45.

14. The lever of claim 10, wherein the second component comprises Vanadis 23.

15. The lever of claim 10, wherein the second component comprises a steel having carbon and chromium.

16. The lever of claim 10, wherein the at least one cam thrust face is formed by a circumferential face of at least one rotatable roller mounted on the lever, the roller produced in one piece as a two-component metal injection molded part or as a combined two-component metal injection molded and ceramic injection molded part or as a two-component sintered part, the circumferential face formed by the second component, and a roller body formed by the first component.

17. A switchable rocker arm comprising:
a valve actuation lever having:
on an underside of one end of the valve actuation lever a contact pad configured to contact at least one gas exchange valve; and,
on an underside of an opposite end of the valve actuation lever a contact face configured for a support element; and,
a pivotable switching lever; one end of the switching is articulated, via a projection, to the valve actuation lever by an axle; an opposite end of the switching lever can be engaged, via a transverse web, to the valve actuation lever with a coupling assembly; at least one cam thrust face is arranged on an upper side of at least the switching lever or the valve actuation lever, in a region between the ends of the switching lever or the ends of the valve actuation lever; and,
the valve actuation lever and/or the switching lever are produced in one piece as a two-component metal injection molding part, or as a combined two-component metal injection molding and ceramic injection molding part, or as a two-component sintered part having two metal components, or having one metal component and one ceramic component; and,
a valve actuation lever material and/or a switching lever material comprise a first component and a second component, the second component forming at least the at least one cam thrust face.

18. The switchable rocker arm of claim 17, wherein the at least one cam thrust face of the valve actuation lever and/or the switching lever is formed by at least one circumferential face of at least one rotatable roller mounted on the valve actuation lever and/or the switching lever, the at least one roller produced in one piece as a two-component metal injection molded part or as a combined two-component metal injection molded and ceramic injection molded part or as a two-component sintered part, the at least one circumferential face formed by the second component, and an at least one roller body formed by the first component.

19. The switchable rocker arm of claim 17, wherein load-bearing regions of the valve actuation lever and/or the switching lever are formed from the first component.

20. The switchable rocker arm of claim 17, wherein:
the first component is a material having a core hardness that is less than a surface hardness; and,
the second component is a material that maintains a constant hardness throughout its depth.

21. The switchable rocker arm of claim 17, wherein:
the first component is a roller bearing steel; and,
the second component is a high-speed steel.

22. The switchable rocker arm of claim 17, wherein the first component comprises a roller bearing steel of either of types 100Cr6, 16MnCr5 or C45.

23. The switchable rocker arm of claim 17, wherein the second component comprises Vanadis 23.

24. The switchable rocker arm of claim 17, wherein the second component comprises a steel having carbon and chromium.

25. The switchable rocker arm of claim 17, wherein the coupling assembly is hydraulically disengaged from the transverse web.

26. The switchable rocker arm of claim 17, further comprising at least one spring arranged between the valve actuation lever and the switching lever.

27. A method for forming at least one of the valve actuation lever or the switching lever of the switchable rocker arm of claim 17, comprising:
injection-molding the first and second components;
drying the first and second components;
debinding the first and second components; and,
heating the first and second components.
